(19) United States
(12) Patent Application Publication
(10) Pub. No.: US 2022/0164859 A1
(43) Pub. Date: May 26, 2022

(54) ORDER PLACING METHOD AND DEVICE FOR SET MEAL PRODUCT

(71) Applicant: KOUBEI (SHANGHAI) INFORMATION TECHNOLOGY CO., LTD., Shanghai (CN)

(72) Inventors: Heng CHEN, Shanghai (CN); Siyuan CHENG, Shanghai (CN); Shicheng ZHOU, Shanghai (CN); Xinmeng WANG, Shanghai (CN)

(21) Appl. No.: 17/441,649

(22) PCT Filed: Mar. 23, 2020
(86) PCT No.: PCT/CN2020/080727

§ 371 Date: Sep. 21, 2021

(30) Foreign Application Priority Data
Mar. 22, 2019 (CN) 201910220882.5

(51) Int. Cl. G06Q 30/06; G06Q 10/08

(52) U.S. Cl. CPC G06Q 30/0635; G06Q 10/0875

(57) ABSTRACT

The present disclosure discloses methods and devices for ordering package products. The method includes: receiving an order information processing request and generating corresponding order data; if the order information comprises package ordering information, generating, for the package ordering information, purchase data sheets associated with the order data, generating purchase group data sheets associated with the purchase data sheets based on packages as granularities, and generating purchase product details data sheets associated with the purchase group data sheets based on products as granularities; storing the order data, the purchase data sheets, the purchase group data sheets, and the purchase product details data sheets to complete ordering of package products.

### CROSS REFERENCE OF RELATED APPLICATIONS

The present application claims priority to Chinese patent application No. 2019102208825 entitled “ORDER PLACING METHOD AND DEVICE FOR SET MEAL PRODUCT,” filed with the Chinese Patent Office on Mar. 22, 2019, the entire contents of which are incorporated herein by reference.

### TECHNICAL FIELD

The present disclosure relates to the field of computer technology, and in particular, to methods and devices for ordering package products.

### BACKGROUND TECHNIQUE

A products package is a sale form via which a merchant combines different products into a package for sale so to meet requirements of different consumers, increase customer transactions, and maximize profit. A consumer can choose different packages according to his/her consumption budget or preference.

Taking catering as an example, a meal package usually consists of multiple product types, and each product type includes different products. For example, a weekday lunch package includes two types of products: staple food and beverages. Either burger or chicken roll is chosen as the staple food, while any one of orange juice, cola or sprite is chosen as the beverage. So, there are 6 possible combinations for this package, and each combination consists of different products.

In existing methods for ordering products, based on products as granularities, products of the same type are aggregated into one purchase sheet recording information of purchased products, such as product prices and purchase quantities. Such ordering methods are obviously not applicable to product packages, because a behavior of ordering a package 1 (burger+cola) and a package 2 (burger+orange juice) is divided into three purchase sheets respectively including burger*2, cola*1, and orange juice*1, which cannot reflect an objective fact that a customer ordered the packages.

### SUMMARY

In view of the above-mentioned problems, the present disclosure provides methods and devices for ordering package products to solve or at least partially solve these problems.

According to an aspect of the present disclosure, there is provided a method for ordering package products, including: receiving an order information processing request and generating corresponding order data; if the order information comprises package ordering information, generating, for the package ordering information, purchase data sheets associated with the order data, generating purchase group data sheets associated with the purchase data sheets based on packages as granularities, and generating purchase product details data sheets associated with the purchase group data sheets based on products as granularities; storing the order data, the purchase data sheets, the purchase group data sheets, and the purchase product details data sheets to complete ordering of package products.

According to another aspect of the present disclosure, there is provided a device for ordering package products, including: a first generating module configured to receive an order information processing request and generate corresponding order data; a second generating module configured to, if the order information comprises package ordering information, generate, for the package ordering information, purchase data sheets associated with the order data, generate purchase group data sheets associated with the purchase data sheets based on packages as granularities, and generate purchase product details data sheets associated with the purchase group data sheets based on products as granularities; a storing module configured to store the order data, the purchase data sheets, the purchase group data sheets, and the purchase product details data sheets to complete ordering of package products.

According to still another aspect of the present disclosure, there is provided a computing device, including: a processor, a memory, a communication interface, and a communication bus, wherein the processor, the memory, and the communication interface communicate with each other through the communication bus; the memory is configured to store at least one executable instruction, and the executable instruction causes the processor to execute corresponding operations in the method of ordering package products as described above.

According to still another aspect of the present disclosure, there is provided a non-volatile computer-readable storage medium having at least one executable instruction stored thereon, wherein the executable instruction causes a processor to execute corresponding operations in the method of ordering package products as described above.

According to still another aspect of the present disclosure, there is provided a computer program product, including: a computer program stored on a non-volatile computer storage medium.

According to the solutions provided by the present disclosure, by generating order data, purchase data sheets associated with the order data, purchase group data sheets associated with the purchase data sheets based on packages as granularities, and purchase product details data sheets associated with the purchase group data sheets based on products as granularities, and storing the above data, ordering of package products is completed, thereby restoring an objective fact that a customer ordered a package, and overcoming a defect that in the prior art, the package ordered by the customer is divided into single products, which cannot reflect that the customer ordered the package.

The above description is only an overview of the technical solutions of the present disclosure. In order to more clearly understand the technical means of the present disclosure, which can be implemented in accordance with the contents of the specification, and in order to make the above and other purposes, features and advantages of the present disclosure more obvious and understandable, specific embodiments of the present disclosure are specifically illustrated below.

### BRIEF DESCRIPTION OF THE DRAWINGS

By reading detailed description of preferred embodiments below, various other advantages and benefits will become clear to those of ordinary skilled in the art. The drawings are only used for the purpose of illustrating the preferred embodiments, and are not considered as a limitation to the present disclosure. Also, throughout the drawings, like reference signs are used to indicate like components. In the drawings:

FIG. 1 shows a schematic flowchart of a method for ordering package products according to an embodiment of the present disclosure;

FIG. 2 shows a schematic flowchart of a method for ordering package products according to another embodiment of the present disclosure;

FIG. 3 shows a schematic structural diagram of a device for ordering package products according to an embodiment of the present disclosure;

FIG. 4 shows a schematic structural diagram of a computing device according to an embodiment of the present disclosure.

### DETAILED DESCRIPTION OF THE EMBODIMENTS

Exemplary embodiments of the present disclosure will be described in more detail below with reference to the accompanying drawings. Although the drawings show the exemplary embodiments of the present disclosure, it should be understood that the present disclosure can be implemented in various forms and should not be limited by the embodiments set forth herein. Rather, these embodiments are provided to enable a more thorough understanding of the present disclosure and to fully convey the scope of the present disclosure to those skilled in the art.

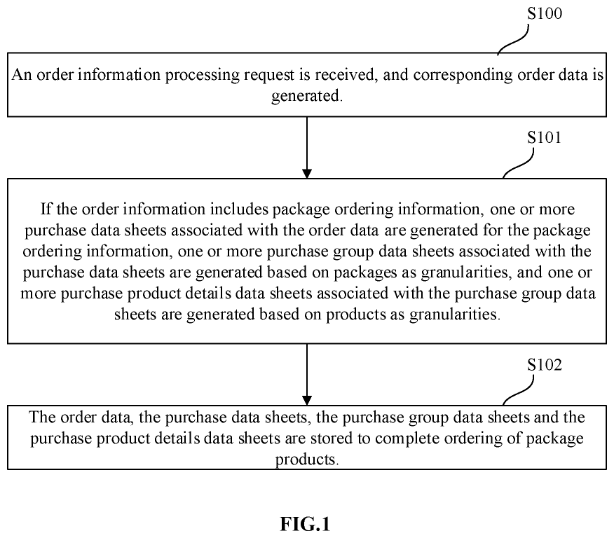

FIG. 1 shows a schematic flowchart of a method for ordering package products according to an embodiment of the present disclosure. As shown in FIG. 1, the method includes the following steps:

At step S100, an order information processing request is received, and corresponding order data is generated.

In this embodiment, a customer can enter an order page to place an order by scanning a code identifier. The code identifier can be a barcode, two-dimensional code, etc. Of course, it is not limited to scanning a code to enter the order page. The customer can enter a merchant home page and then enter a merchant order page to place an order. Here, there is no specific limitation on how the customer enters the order page. The customer can enter the order page in other ways to place an order.

The order page displays products to be sold by the merchant The customer can add products to be purchased this time and set a quantity of the products to be purchased this time according to their needs. After adding the products, the customer submits information about the products to be purchased, that is, an order information processing request. The order information processing request is received, and corresponding order data is generated for order information. The order data describes a customer purchase behavior.

At step S101, if the order information includes package ordering information, one or more purchase data sheets associated with the order data are generated for the package ordering information, one or more purchase group data sheets associated with the purchase data sheets are generated based on packages as granularities, and one or more purchase product details data sheets associated with the purchase group data sheets are generated based on products as granularities.

A package is a combination of multiple products. In order to meet requirements of different consumers while increasing an amount of sales and maximizing profit, merchants combine different products together for sale. For example, a package includes a product A+a product B. This is just an example, and does not have any limiting effect.

When placing an order, a customer may choose to purchase a package because a price of the package is lower than a sum of prices of corresponding products ordered separately. In order to enable an objective fact that the customer ordered packages to be restored, if the order information includes package ordering information, purchase data sheets associated with the order data can be generated for the package ordering information, purchase group data sheets associated with the purchase data sheets are generated based on packages as granularities, and purchase product details data sheets associated with the purchase group data sheets are generated based on products as granularities.

In this embodiment, each order corresponds to a unique order number. When associating the order data, the purchase data sheets, the purchase group data sheets and the purchase product details data sheet, two association manners are included according to whether purchase number and purchase group number are globally unique. Global uniqueness means that a purchase number of each purchase data sheet and a purchase group number of each purchase group data sheet are unique, and there will not exist the case where purchase numbers of multiple purchase data sheets are same. Global non-uniqueness means that purchase numbers of multiple purchase data sheets may be same, and purchase group numbers of multiple purchase group data sheets may be same.

In a first manner, if generated order data includes order number, then generated purchase data sheets may include order number and purchase number, so that the order data and the purchase data sheets can be associated through the order number; a generated purchase group data sheet may include purchase number and purchase group number, so that the purchase data sheets and the purchase group data sheets can be associated through the purchase number; a generated purchase product details data sheet may include purchase group number, so that the purchase group data sheets and the purchase product details data sheets can be associated through the purchase group number. In this embodiment, the order data corresponds to a unique order number. If multiple purchase data sheets associated with the order data are generated, purchase numbers of the multiple purchase data sheets are different. Similarly, purchase group numbers of multiple purchase group data sheets are different.

In a second manner, if a purchase number and a purchase group number are globally non-unique, there may exist the case where purchase numbers of multiple purchase data sheets are same, and purchase group numbers of multiple purchase group data sheets are same, which makes it impossible for the purchase group data sheets to fmd corresponding purchase data sheets based only on purchase numbers recorded in the purchase group data sheets, and impossible for purchase product details data sheets to find corresponding purchase group data sheets based only on purchase group numbers recorded in the purchase product details data sheet.

In this case, in order to enable the corresponding purchase data sheets and purchase group data sheets to be uniquely found, the following associations can be performed: if generated order data includes order number, then generated purchase data sheets may include order number and purchase number, so that the order data and the purchase data sheets can be associated through the order number; a generated purchase group data sheet may include the order number, the purchase number, and purchase group number, so that the purchase data sheets and the purchase group data sheets can be associated through the order number and the purchase number; a generated purchase product details data sheet may include the order number, the purchase number, and the purchase group number, so that the purchase group data sheet and the purchase product details data sheet can be associated through the order number, the purchase number, and the purchase group number. Through the above-mentioned associations, relevant data can be accurately found.

At step S102, the order data, the purchase data sheets, the purchase group data sheets and the purchase product details data sheets are stored to complete ordering of package products.

The order data, the purchase data sheets, the purchase group data sheets and the purchase product details data sheet, after being generated, are stored. After the storage is completed, the ordering of package products is completed, avoiding an impossibility to restore an objective fact that a customer ordered a package after the customer purchased the package in the prior art.

According to the method provided by the above-mentioned embodiment of the present disclosure, by generating order data, purchase data sheets associated with the order data, purchase group data sheets associated with the purchase data sheets based on packages as granularities, and purchase product details data sheets associated with the purchase group data sheets based on products as granularities, and storing the above data, ordering of package products is completed, thereby restoring an objective fact that a customer ordered a package, and overcoming a defect that in the prior art, the package ordered by the customer is divided into single products, which cannot reflect that the customer ordered the package.

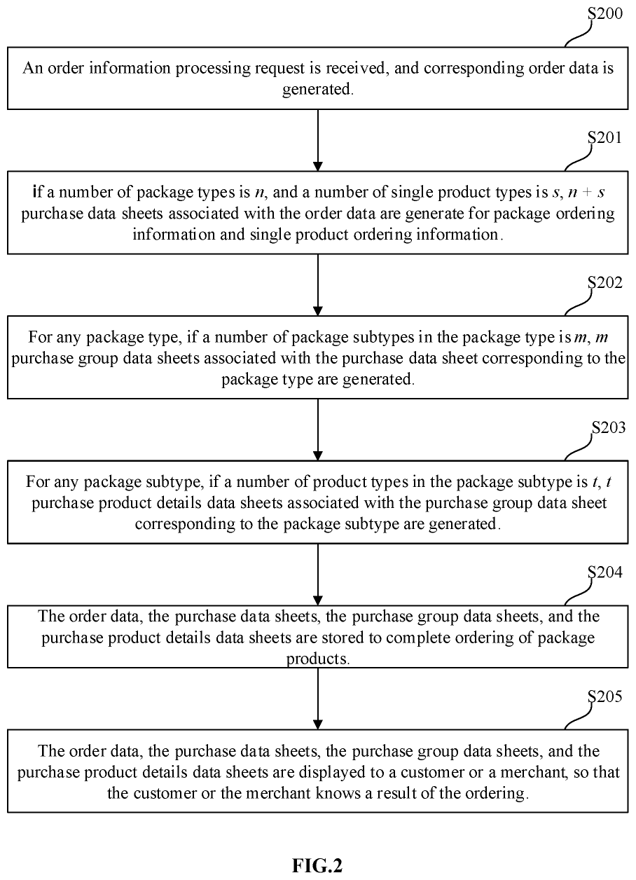

FIG. 2 shows a schematic flowchart of a method for ordering package products according to another embodiment of the present disclosure. As shown in FIG. 2, the method includes the following steps:

As step S200, an order information processing request is received, and corresponding order data is generated.

In this embodiment, a customer can enter an order page to place an order by scanning a code identifier. The code identifier can be a barcode, two-dimensional code, etc. Of course, it is not limited to scanning a code to enter the order page. The customer can enter a merchant home page and then enter a merchant order page to place an order. Here, there is no specific limitation on how the customer enters the order page. The customer can enter the order page in other ways to place an order.

The order page displays products to be sold by the merchant The customer can add products to be purchased this time and set a quantity of the products to be purchased this time according to their needs. After adding the products, the customer submits information about the products to be purchased, that is, an order information processing request. The order information processing request is received, and corresponding order data is generated for the order information. The order data describes a customer purchase behavior, and records information such as an order number, a customer identifier, an order price, an order status, and an order note.

In real life, customers may purchase packages and single products at the same time. Here, for example, the order information includes package ordering information and single product ordering information. The package ordering information includes a number of package types, a number of package subtypes in each package type, and a number of product types in each package subtype. The single product ordering information includes a number of single product types.

Usually, merchants will set a variety of different package types, such as a weekday package type and a snack package type, which will not be listed one by one here. For some package types, merchants may set a variety of combinations. Here, each combination of package products is called a package subtype. For example, a weekday package type is set. The weekday package type mainly includes two types of products: staple food and beverages. Either of burger or chicken roll can be chosen as the staple food. Any of orange juice, cola or sprite can be chosen as the beverage. So, there are 6 different combinations. Combinations such as “burger+orange juice” and “burger+cola” belong to package subtypes in the weekday package type. Each package subtype includes a plurality of product types. For example, in the package subtype of “burger+orange juice,” there are two product types. Of course, in real life, merchants will set some types of packages with a fixed combination, and customers cannot combine products at will. For such type of package with a fixed combination, it can be regarded that the number of package subtypes in the package with a fixed combination is 1.

At step S201, if a number of package types is n, and a number of single product types is s, n+s purchase data sheets associated with the order data are generated for package ordering information and single product ordering information.

After a customer places an order, order information can be obtained. If the customer orders n types of packages and s types of single products, it can be determined that the number of package types is n, and the number of single product types is s. For the package ordering information and the single products ordering information, n+s purchase data sheets associated with order data are generated. In this embodiment, each package type corresponds to one piece of purchase data sheets, and each single product type corresponds to one piece of purchase data sheets.

For example, order information includes 2 weekday packages, 1 snack package, and 1 single product A. It can be determined that the number of package types is 2, and the number of single product types is 1. For the package ordering information and the single product ordering information, 3 purchase data sheets associated with order data are generated. The 2 weekday packages correspond to 1 piece of purchase data sheets. The 1 snack package corresponds to 1 piece of purchase data sheets. The 1 single product A corresponds to 1 piece of purchase data sheets.

For a single product, the generated purchase data sheet can be regarded as data based on products as granularities. The purchase data sheet corresponds to 0 purchase group data sheets.

At step S202, for any package type, if a number of package subtypes in the package type is m, m purchase group data sheets associated with the purchase data sheets corresponding to the package type are generated.

As described above, merchants may set multiple package subtypes for a certain package type. Therefore, there may exist a case where, for a certain package type, a customer may order multiple package subtypes. At this time, a number of package subtypes in the certain package type can be firstly determined, for example, m package subtypes, and then m purchase group data sheets associated with purchase data sheets corresponding to the certain package type are generated.

For example, a weekday package mainly includes two types of products: staple food and beverages. Either of burger or chicken roll can be chosen as the staple food. Any of orange juice, cola or sprite can be chosen as the beverage. So there are 6 different package subtypes. If a customer orders 2 packages, “burger+orange juice” and “burger+cola” for the weekday packages, it can be determined that a number of package subtypes in weekday package type is 2, and 2 purchase group data sheets associated with purchase data sheets corresponding to the weekday packages are generated, one of which is a purchase group data sheet about the package subtype “burger+orange juice,” and the other is a purchase group data sheet about the package subtype “burger +cola.”

For a type of package with a fixed combination, for example, snack package type, it can be regarded that a number of package subtypes in the snack package type is 1, 1 purchase group data sheet associated with purchase data sheets corresponding to the snack packages is generated.

At step S203, for any package subtype, if a number of product types in the package subtype is t, t purchase product details data sheets associated with the purchase group data sheet corresponding to the package subtype are generated.

Each package ordered by a customer is composed of multiple products. Usually, each product belongs to one type of products. Therefore, for any package subtype ordered by a customer, a number of product types in the package subtype can be determined, for example, t product types, and then t purchase product details data sheets associated with the purchase group data sheet corresponding to the package subtype are generated. The purchase product details data sheets record details of products purchased by the customer, etc.

In this embodiment, a purchase data sheet includes purchase price, package unit-price data, and purchase price adjustment data. A purchase group data sheet includes package unit-price data, and purchase group price adjustment data. A purchase product details data sheet includes product price adjustment data.

The purchase price adjustment data is a sum of products obtained by multiplying each piece of product price adjustment data in all purchase product details data sheets associated with the purchase data sheets, with corresponding product quantity. The purchase price is a sum of the purchase price adjustment data plus a product obtained by multiplying the package unit-price data with corresponding package quantity.

For example, a unit-price of a weekday package is 30 yuan, including two types of products: staple food and beverages. Either of burger or chicken roll is chosen as the staple food. Any of orange juice, cola or sprite is chosen as the beverage. If the burger is chosen as the staple food, 3 yuan needs to be added to the unit-price of the weekday package, and if the orange juice is chosen as the beverage, 2 yuan needs to be added to the unit-price of the weekday package. If a customer orders one package “burger+orange juice” and one package “burger+cola,” accordingly generated purchase data sheets includes purchase price 68 yuan, package unit-price data 30 yuan, and purchase price adjustment data 8 yuan. 2 purchase group data sheets are generated, in which a purchase group data sheet corresponding to the package “burger+orange juice” includes package unit-price data 30 yuan and purchase group price adjustment data 5 yuan; a purchase group data sheet corresponding to the package “burger+cola” includes package unit-price data 30 yuan and purchase group price adjustment data 3 yuan. 2 purchase product details data sheets corresponding to the package “burger+orange juice” are generated, in which a purchase product details data sheet corresponding to burger includes product price adjustment data 3 yuan, and a purchase product details data sheet corresponding to orange juice includes product price adjustment data 2 yuan. 2 purchase product details data sheets corresponding to the package “burger+cola” are generated, in which a purchase product details data sheet corresponding to burger includes product price adjustment data 3 yuan, and a purchase product details data sheet corresponding to cola includes product price adjustment data 0 yuan.

In addition, the purchase data sheets may further include: purchase number, order number, product ID, product name and other information. The purchase product details data sheets may further include: product ID, product name, product quantity and other information. Information items included in the order data, the purchase data sheets, the purchase group data sheets, and the purchase product details data sheets are merely simply listed in this embodiment, and can be flexibly set by those skilled in the art according to actual needs.

In this embodiment, for association between order data and purchase data sheets, association between the purchase data sheets and purchase group data sheets, and association between the purchase group data sheets and purchase product details data sheet, reference can be made to association manners corresponding to method steps in the embodiment shown in FIG. 1, which will not be repeated here.

At step S204, the order data, the purchase data sheets, the purchase group data sheets, and the purchase product details data sheets are stored to complete ordering of package products.

The order data, the purchase data sheets, the purchase group data sheets and the purchase product details data sheet, after being generated, are stored. After the storage is completed, the ordering of package products is completed, avoiding an impossibility to restore an objective fact that a customer ordered a package after the customer purchased the package in the prior art.

At step S205, the order data, the purchase data sheets, the purchase group data sheets, and the purchase product details data sheets are displayed to a customer or a merchant, so that the customer or the merchant knows a result of the ordering.

Order data, purchase data sheets, purchase group data sheets, and purchase product details data sheets, after being stored, can be displayed as needed. Specifically, the order data, the purchase data sheets, the purchase group data sheets, and the purchase product details data sheets can be displayed to a customer or a merchant, so that the customer or the merchant knows a result of the ordering.

In this embodiment, by displaying order data, purchase data sheets, purchase group data sheets, and purchase product details data sheets to a customer, the customer can know which products he/she has ordered, and these data can be used as a basis for checking order information of the customer;

By displaying the order data, the purchase data sheets, the purchase group data sheets and the purchase product details data sheets to a merchant, the merchant can know which packages customers have ordered, count which packages are sold well, and adjust the packages in his/her store in time.

Below, a description will be made with reference to specific examples. A customer, after entering an order page of Burger King, adds 2 weekday packages, “burger+orange juice” and “burger+cola,” and further adds 1 snack package, “New Orleans Roasted Wing+Popcorn Chicken,” and 1 single product “French Fries.” A unit-price of the weekday package is 30 yuan. If burger is chosen as the staple food, 3 yuan needs to be added to the unit-price of the package. If orange juice is chosen as a beverage, 2 yuan needs to be added to the unit-price of the package. A unit-price of the snack package is 20 yuan. A unit-price of the single product “French Fries” is 5 yuan.

Using the method for ordering package products provided in the present disclosure, a customer, after confirming his/her order, submits an order information processing request. After the order information processing request is received, order information is processed to generate corresponding order data. For example, the generated order data includes information such as order number, customer ID, order price, order status, and order note. For the order information, it can be determined that a number of package types is 2. A number of package subtypes in a weekday package is 2, and a number of product types in each package subtype is 2. A number of package subtypes in a snack package is 1, and a number of product types in the package subtype is 2. A number of single product types is 1. Therefore, for the package ordering information and the single product ordering information, 3 purchase data sheets associated with order data are generated, and the 3 purchase data sheets correspond to the weekday packages, the snack package and the single product “French Fries.” For the weekday packages, the generated purchase data sheets include purchase price 68 yuan, package unit-price data 30 yuan, and purchase price adjustment data 8 yuan. For the snack package, the generated purchase data sheets include purchase price 20 yuan, package unit-price data 20 yuan, and purchase price adjustment data 0 yuan. For the single product “French Fries,” the generated purchase data sheets include purchase price 20 yuan, product unit-price 20 yuan, and purchase price adjustment data 0 yuan. In addition, the purchase data sheets may further include information such as order number and purchase number. The order data can be associated with the purchase data sheets through the order number.

For a weekday package, if a number of package subtypes is 2, 2 purchase group data sheets associated with purchase data sheets corresponding to the package subtypes are generated, one of which corresponds to a package “burger+orange juice,” and includes package unit-price data 30 yuan and purchase group price adjustment data 5 yuan, while the other corresponds to a package “burger+cola,” and includes package unit-price data 30 yuan and purchase group price adjustment data 3 yuan. Each package subtype includes 2 product types. It can be determined that the number of product types in each of the 2 package subtypes is 2. For each package subtype, 2 purchase product details data sheets associated with a purchase group data sheet corresponding to the package subtype are generated. In the package “burger+orange juice,” a purchase product details data sheet corresponding to the burger includes product price adjustment data 3 yuan, and a purchase product details data sheet corresponding to the orange juice includes product price adjustment data 2 yuan. In the package “burger+cola,” a purchase product details data sheet corresponding to the burger includes product price adjustment data 3 yuan, and a purchase product details data sheet corresponding to the cola includes product price adjustment data 0 yuan.

For a snack package, if a number of package subtypes is 1, 1 purchase group data sheet associated with purchase data sheets corresponding to the package subtype is generated. The corresponding purchase group data sheet includes package unit-price data 20 yuan and purchase group price adjustment data 0 yuan. In a package “New Orleans Roasted Wing+Popcorn Chicken,” a purchase product details data sheet corresponding to the New Orleans Roasted Wing includes product price adjustment data 0 yuan, and a purchase product details data sheet corresponding to the Popcorn Chicken includes product price adjustment data 0 yuan.

For a single product French Fries, purchase price adjustment data in purchase data sheets is 0 yuan, and 0 purchase group data sheets are generated.

After the above data is generated, the order data, the purchase data sheets, the purchase group data sheets, and the purchase product details data sheets are stored to complete ordering of package products, and the order data, the purchase data sheets, the purchase group data sheets, and the purchase product details data sheets are displayed to a customer or a merchant, so that the customer or the merchant knows a result of the ordering.

In an optional embodiment of the present disclosure, if order information includes only package ordering information, generating purchase data sheets associated with the order data specifically comprises: if a number of package types is n, n purchase data sheets corresponding to the order data are generated.

Generating purchase group data sheets associated with the purchase data sheets based on packages as granularities further includes: for any package type, if a number of package subtypes in the package type is m, m purchase group data sheets associated with the purchase data sheets corresponding to the package type are generated.

Generating purchase product details data sheets associated with the purchase group data sheets based on products as granularities further includes: for any package subtype, if a number of product types in the package subtype is t, t purchase product details data sheets associated with a purchase group data sheet corresponding to the package subtype are generated.

The specific implementation of the above method steps is similar to that of corresponding method steps in FIG. 2, which will not be repeated here.

The method for ordering package products provided in this disclosure is suitable not only for ordering packages, but also for a case where a customer only orders single products. If order information includes only single product ordering information, and a number of single product types is s, s purchase data sheets associated with the order data are generated for the single product ordering information. At this time, the purchase data sheets include 0 purchase group data sheets, and purchase price adjustment data in the purchase data sheets corresponds to 0 yuan.

According to the method provided by the above embodiment of the present disclosure, by generating order data, purchase data sheets associated with the order data, purchase group data sheets associated with the purchase data sheets based on packages as granularities, and purchase product details data sheets associated with the purchase group data sheets based on products as granularities, and storing the above data, ordering of package products is completed, thereby restoring an objective fact that a customer ordered a package, and overcoming a defect that in the prior art, the package ordered by the customer is divided into single products to generate purchase data sheets, which cannot reflect that the customer ordered the package. By displaying the order data, the purchase data sheets, the purchase group data sheets, and the purchase product details data sheets to a customer or a merchant, the customer can know which products have been ordered and check order information, and the merchant can know which package customers have ordered, count which packages are sold well, and adjust the packages in his/her store in time. For package products that involve price adjustments, package features such as package unit-price data and purchase price adjustment data can be accurately described. In addition, ordering of packages and/or single products is compatible with this solution, which has a wider application range.

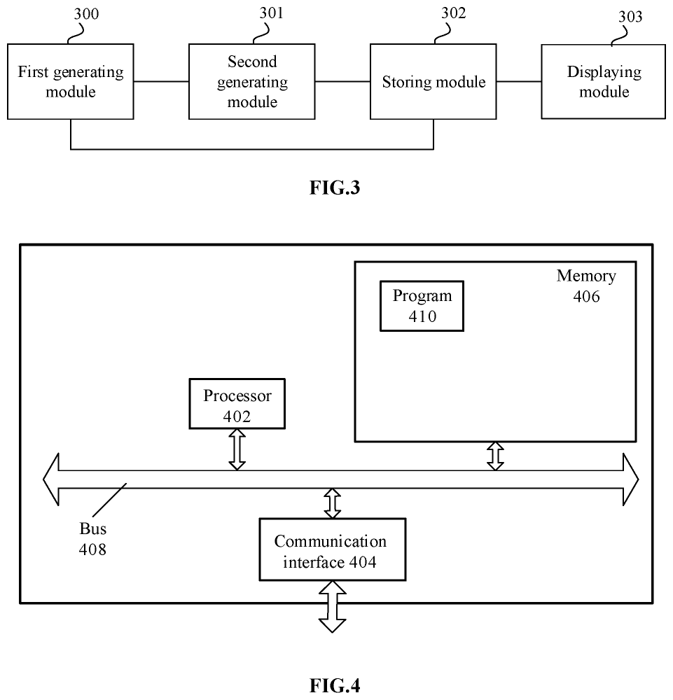

FIG. 3 shows a schematic structural diagram of a device for ordering package products according to an embodiment of the present disclosure. As shown in FIG. 3, the device includes a first generating module 300, a second generating module 301, and a storing module 302.

The first generating module 300 is configured to receive an order information processing request and generate corresponding order data.

The second generating module 301 is configured to if order information comprises package ordering information, generate, for the package ordering information, purchase data sheets associated with the order data, generate purchase group data sheets associated with the purchase data sheets based on packages as granularities, and generate purchase product details data sheets associated with the purchase group data sheets based on products as granularities.

The storing module 302 is configured to store the order data, the purchase data sheets, the purchase group data sheets, and the purchase product details data sheets to complete ordering of package products.

Optionally, the package ordering information comprises a number of package types, a number of package subtypes in each package type, and a number of product types in each package subtype.

The second generating module 301 is further configured to: if the number of package types is n, generate n purchase data sheets corresponding to the order data; for any package type, if a number of package subtypes in the package type is m, generate m purchase group data sheets associated with purchase data sheets corresponding to the package type; for any package subtype, if a number of product types in the package subtype is t, generate t purchase product details data sheets associated with a purchase group data sheet corresponding to the package subtype.

Optionally, the purchase data sheet includes purchase price, package unit-price data, and purchase price adjustment data; the purchase group data sheet comprises package unit-price data and purchase group price adjustment data; the purchase product details data sheet comprises product price adjustment data.

The purchase price adjustment data is a sum of products obtained by multiplying each piece of product price adjustment data, in all purchase product details data sheets associated with the purchase data sheets, with corresponding product quantity.

The purchase price is a sum of the purchase price adjustment data plus a product obtained by multiplying the package unit-price data with corresponding package quantity.

Optionally, the order information further comprises single product ordering information. The second generating module 301 is further configured to: if a number of package types is n, and a number of single product types is s, generate, for the package ordering information and the single product ordering information, n+s purchase data sheets associated with the order data.

Optionally, the device further comprises a displaying module 303 configured to display the order data, the purchase data sheets, the purchase group data sheets, and the purchase product details data sheets to a customer or a merchant, so that the customer or the merchant knows a result of the ordering.

According to the device provided by the above-mentioned embodiment of the present disclosure, by generating order data, purchase data sheets associated with the order data, purchase group data sheets associated with the purchase data sheets based on packages as granularities, and purchase product details data sheets associated with the purchase group data sheets based on products as granularities, and storing the above data, ordering of package products is completed, thereby restoring an objective fact that a customer ordered a package, and overcoming a defect that in the prior art, the package ordered by the customer is divided into single products, which cannot reflect that the customer ordered the package.

The method and device for ordering package products provided by the present disclosure are applicable to various scenarios involving the ordering of package products, such as a catering scenario and a commodity retail scene, which will not be listed here.

An embodiment of the present disclosure further provides a non-volatile computer-readable storage medium having at least one executable instruction stored thereon. The computer-executable instruction can execute the method for ordering package products in any of the above method embodiments.

FIG. 4 shows a schematic structural diagram of a computing device according to an embodiment of the present disclosure. The specific embodiment of the present disclosure does not limit the specific implementation of the computing device.

As shown in FIG. 4, the computing device may include a processor 402, a communication interface 404, a memory 406, and a communication bus 408. Where: the processor 402, the communication interface 404, and the memory 406 communicate with each other through the communication bus 408; the communication interface 404 is configured to communicate with other devices such as network elements of client devices, other servers or the like; the processor 402 is configured to execute a program 410, and specifically can execute relevant steps in the embodiment of the method for ordering package products as described above.

Specifically, the program 410 may include program codes, and the program codes include computer operation instructions.

The processor 402 may be a Central Processing Unit CPU, or an Application Specific Integrated Circuit ASIC, or one or more integrated circuits configured to implement the embodiments of the present disclosure. The one or more processors included in the computing device may be the same type of processors, such as one or more CPUs, or different types of processors, such as one or more CPUs and one or more ASICs.

The memory 406 is configured to store the program 410. The memory 406 may include a high-speed RAM memory, and may further include a non-volatile memory, for example, at least one magnetic disk memory.

The program 410 may be specifically configured to enable the processor 402 to execute the method for ordering package products in any of the above method embodiments. The specific implementation of steps in the program 410 can be found in corresponding description in corresponding steps and units in the above-mentioned embodiment of ordering package products, which will not be repeated here. Those skilled in the art can clearly understand that, for convenience and conciseness of description, for specific working processes of the devices and modules described above, reference can be made to corresponding description of processes in the above method embodiments, which will not be repeated here.

The algorithms and displays provided here are not inherently related to any particular computer, virtual system or other equipment. Various general-purpose systems can also be used based on the teachings herein. Based on the above description, the structure required to construct this type of system is obvious. In addition, the present disclosure is not directed to any specific programming language. It should be understood that various programming languages can be used to implement the contents of the present disclosure described herein, and the above description of a specific language is for the purpose of disclosing the best embodiment of the present disclosure.

In the specification provided here, a lot of specific details are explained. However, it can be understood that the embodiments of the present disclosure may be practiced without these specific details. In some examples, the well-known methods, structures, and techniques are not shown in detail, so as not to obscure the understanding of this specification.

Similarly, it should be understood that in order to simplify the present disclosure and help understand one or more of the various disclosed aspects, in the above description of the exemplary embodiments of the present disclosure, the features of the present disclosure are sometimes grouped together into a single embodiment, drawing, or its description. However, the disclosed method should not be interpreted as reflecting the intention that the claimed disclosure requires more features than those explicitly recorded in each claim. More precisely, as reflected in the appended claims, the disclosed aspects lie in being less than all features of a single embodiment previously disclosed. Therefore, the claims following the specific embodiments are thus explicitly incorporated into the specific embodiments, wherein each claim itself serves as a separate embodiment of the present disclosure.

Those skilled in the art can understand that it is possible to adaptively change the modules in the devices in the embodiments and set them in one or more devices different from the embodiments. The modules or units or components in the embodiments can be combined into one module or unit or component, and in addition, they can be divided into multiple sub-modules or sub-units or sub-components. Except that at least some of such features and/or processes or units are mutually exclusive, any combination can be used to combine all the features disclosed in this specification (including the appended claims, abstract and drawings) and all the processes or units of any method or device disclosed in this way. Unless expressly stated otherwise, each feature disclosed in this specification (including the appended claims, abstract and drawings) may be replaced by an alternative feature providing the same, equivalent or similar purpose.

In addition, those skilled in the art can understand that although some embodiments described herein include certain features included in other embodiments, but not other features, the combination of features in different embodiments means that they are within the scope of the present disclosure and form different embodiments. For example, in the following claims, any of the claimed embodiments can be used in any combination.

The various component embodiments of the present disclosure may be implemented by hardware, or by software modules running on one or more processors, or by a combination thereof Those skilled in the art should understand that a microprocessor or a digital signal processor (DSP) may be used in practice to implement some or all of the functions of some or all of the components in the device for ordering package products according to the embodiments of the present disclosure. The present disclosure can also be implemented as a device or device program (for example, a computer program and a computer program product) for executing part or all of the methods described herein. Such a program for realizing the present disclosure may be stored on a computer-readable medium, or may have the form of one or more signals. Such signals can be downloaded from an Internet website, or provided on a signal carrier or in any other form.

It should be noted that the above-mentioned embodiments illustrate rather than limit the present disclosure, and those skilled in the art can design alternative embodiments without departing from the scope of the appended claims. In the claims, any reference sign placed between parentheses should not be formed as a limitation to the claims. The word “consist of” or “composed of” does not exclude the presence of elements or steps not listed in the claims. The word “a” or “an” preceding an element does not exclude the presence of multiple such elements. The present disclosure can be realized by means of hardware including several different elements and by means of a computer appropriately programmed. In claims enumerating units of several devices, some of these devices may be embodied in the same hardware item. The use of the words “first,” “second,” “third,” etc. does not indicate any order. These words can be interpreted as names

What is claimed is:

1. A method of ordering package products, comprising:
receiving an order information processing request and generating corresponding order data;
if the order information comprises package ordering information, for the package ordering information,
generating one or more purchase data sheets associated with the order data,
generating one or more purchase group data sheets associated with the purchase data sheets based on packages as granularities, and
generating one or more purchase product details data sheets associated with the purchase group data sheets based on products as granularities;
storing the order data, the purchase data sheets, the purchase group data sheets, and the purchase product details data sheets to complete ordering of package products.

2. The method according to claim 1, wherein the package ordering information comprises a number of package types, a number of package subtypes in each package type, and a number of product types in each package subtype;
generating the one or more purchase data sheets associated with the order data specifically comprises:
if the number of package types is n, generating n purchase data sheets corresponding to the order data;
generating the one or more purchase group data sheets associated with the purchase data sheets based on packages as granularities further comprises:
for any one of the package types, if a number of package subtypes in the package type is m, generating m purchase group data sheets associated with the purchase data sheets corresponding to the package type;
generating the one or more purchase product details data sheets associated with the purchase group data sheets based on products as granularities further comprises:
for any one of the package subtypes, if a number of product types in the package subtype is t, generating t purchase product details data sheets associated with a purchase group data sheet corresponding to the package subtype.

3. The method according to claim 1, wherein
the purchase data sheet comprises purchase price, package unit-price data, and purchase price adjustment data;
the purchase group data sheet comprises package unit-price data, and purchase group price adjustment data;
the purchase product details data sheet comprises product price adjustment data,
wherein the purchase price adjustment data is a sum of products obtained by multiplying each piece of product price adjustment data, in all purchase product details data sheets associated with the purchase data sheets, with corresponding product quantity;
the purchase price is a sum of the purchase price adjustment data plus a product obtained by multiplying the package unit-price data with corresponding package quantity.

4. The method according to claim 1, wherein the order information further comprises single product ordering information; for the package ordering information, generating the purchase data sheets associated with the order data further comprises:
if a number of package types is n, and a number of single product types is s, generating, for the package ordering information and the single product ordering information, n+s purchase data sheets associated with the order data.

5. The method according to claim 1, wherein, after storing the order data, the purchase data sheets, the purchase group data sheets, and the purchase product details data sheets, the method further comprises:
displaying the order data, the purchase data sheets, the purchase group data sheets, and the purchase product details data sheets to a customer or a merchant, so that the customer or the merchant knows a result of the ordering.

6. A device of ordering package products, comprising:
a first generating module configured to receive an order information processing request and generate corresponding order data;
a second generating module configured to, if the order information comprises package ordering information, for the package ordering information,
generate one or more purchase data sheets associated with the order data,
generate one or more purchase group data sheets associated with the purchase data sheets based on packages as granularities, and
generate one or more purchase product details data sheets associated with the purchase group data sheets based on products as granularities;
a storing module configured to store the order data, the purchase data sheets, the purchase group data sheets, and the purchase product details data sheets to complete ordering of package products.

7. The device according to claim 6, wherein the package ordering information comprises a number of package types, a number of package subtypes in each package type, and a number of product types in each package subtype; the second generating module is further configured to:
if the number of package types is n, generate n purchase data sheets corresponding to the order data;
for any package type, if a number of package subtypes in the package type is m, generate m purchase group data sheets associated with purchase data sheets corresponding to the package type;
for any package subtype, if a number of product types in the package subtype is t, generate t purchase product details data sheets associated with a purchase group data sheet corresponding to the package subtype.

8. The device according to claim 6, wherein
the purchase data sheet comprises purchase price, package unit-price data, and purchase price adjustment data;
the purchase group data sheet comprises package unit-price data, and purchase group price adjustment data;
the purchase product details data sheet comprises product price adjustment data,
wherein the purchase price adjustment data is a sum of products obtained by multiplying each piece of product price adjustment data, in all purchase product details data sheets associated with the purchase data sheets, with corresponding product quantity;
the purchase price is a sum of the purchase price adjustment data plus a product obtained by multiplying the package unit-price data with corresponding package quantity.

9. The device according to claim 6, wherein the order information further comprises single product ordering information;
the second generating module is further configured to:
if a number of package types is n, and a number of single product types is s, generate, for the package ordering information and the single product ordering information, n+s purchase data sheets associated with the order data.

10. The device according to claim 6, further comprising: a displaying module configured to display the order data, the purchase data sheets, the purchase group data sheets, and the purchase product details data sheets to a customer or a merchant, so that the customer or the merchant knows a result of the ordering.

11-13. (canceled)
